(19) United States
(12) Patent Application Publication
(10) Pub. No.: US 2022/0195267 A1
(43) Pub. Date: Jun. 23, 2022

(54) ONE-COMPONENT TOUGHENED EPOXY ADHESIVES WITH IMPROVED HUMIDITY RESISTANCE

(71) Applicant: DDP Specialty Electronic Materials US, LLC, Wilmington, DE (US)

(72) Inventors: ANDREAS LUTZ, Freienbach (CH); DANIEL SCHNEIDER, Freienbach (CH); JEANNINE FLUECKIGER, Freienbach (CH); FELIX KOCH, Freienbach (CH)

(21) Appl. No.: 17/595,410

(22) PCT Filed: May 28, 2020
(86) PCT No.: PCT/US2020/034807

§ 371 Date: Nov. 16, 2021

Related U.S. Application Data
(60) Provisional application No. 62/863,118, filed on Jun. 18, 2019.

(51) Int. Cl. C09J 163/00; C08G 18/48; C08G 18/73; C08G 18/69; C08L 63/00

(52) U.S. Cl. CPC C09J 163/00; C08G 18/4854; C08L 2205/03; C08G 18/698; C08L 63/00; C08G 18/73

(57) ABSTRACT

The present invention is a toughened one component epoxy adhesive composition demonstrating improved resistance to humidity. Wherein said one-part structural adhesive comprises: A) a blocked PU-polymer toughener compound; B) an epoxy resin component comprising a solid epoxy resin, a liquid epoxy resin, or mixture thereof; C) a curing agent; D) a urea compound; and E) optionally a filler, wherein the blocked PU-polymer toughener (A) is a reaction product of a reaction mixture comprising of: i) a polyether, ii) a hydroxyl-terminated polybutadiene, iii) a polyisocyanate, iv) a chain extender, and v) a capping group.

### FIELD OF THE INVENTION

This invention relates to one-component epoxy adhesive compositions that demonstrate improved humidity resistance. Said one component epoxy adhesive composition comprises a blocked PU-polymer toughener compound, an epoxy resin component, a curing agent, and a urea compound. The blocked PU-polymer toughener is a reaction product of a reaction mixture comprising: a polyether, a hydroxyl-terminated polybutadiene, a polyisocyanate, and a capping group.

### BACKGROUND OF THE INVENTION

Structural epoxy based one component body shop adhesives are widely used in automotive manufacturing. In the automotive industry, for some bonding applications there is a requirement that the adhesives be optimized with regard to resist humid environmental conditions in the uncured stage. Poor humidity resistance can compromise the cured adhesive strength performance (i.e., higher loss of strength) and/or its failure mode to the substrate (i.e., less cohesive and more adhesive failure, bubbles in the adhesive layer caused by degassing water when adhesive is curing in the e-coat oven). There are a variety of common manufacturing situations where extended exposure to humid conditions prior to cure exist.

For example, in a pre-series build of a new car model, adhesives are applied, the body structure and the closure panels are built, but the vehicle is not immediately run through the e-coat process and may actually sit for an extended amount of time prior to the heat treatment. Thus, the adhesive sits uncured and is exposed to outside humidity and temperature conditions until cured in the e-coat oven.

Another common manufacturing practice in the automotive industry is to manufacture parts in one country or region, then export and/or ship to another location (e.g., country or region) for final assembly. This is called CKD (complete knock-down). Parts, like doors or entire car bodies, are built in one location and then shipped to another location for assembly before they are run through the e-coat process where adhesive will be cured.

In many countries, manufacturing sites experience discontinuous work cycles, for example holiday breaks. Prior to a break, vehicles or parts that are built may not be run through the entire e-coat process. The line stops for the break, then the vehicle or parts are run through the e-coat process once manufacturing resumes.

For these, and any other, manufacturing situations where there is an extended time period between application and cure of a one component epoxy adhesive, it would be desirable to have an adhesive technology wherein the bulk adhesive demonstrates an increase in resistance to humidity.

### SUMMARY OF THE INVENTION

The present invention is a one-part structural adhesive comprising: A) a blocked PU-polymer toughener compound; B) an epoxy resin component comprising a solid epoxy resin, a liquid epoxy resin, or mixture thereof; C) a curing agent; D) a urea compound, preferably a phenyl dimethyl urea or aliphatic dimethyl-urea; and E) optionally a filler, preferably one or more of fumed silica, calcium carbonate, calcium oxide, wollastonite, talc, glass beads, and hollow glass spheres, wherein the blocked PU-polymer toughener (A) is a reaction product of a reaction mixture comprising: i) a polyether, preferably a polytetrahydrofuran-diol polymer ii) a hydroxyl-terminated polybutadiene, iii) a polyisocyanate, preferably 1,6-hexamethylene diisocyanate, iv) a chain extender, preferably a bisphenol, and v) a capping group, preferably cashew nut shell liquid oil.

In one embodiment of the present invention, the one-part structural adhesive described herein above comprises an epoxy resin (B) having the formula:

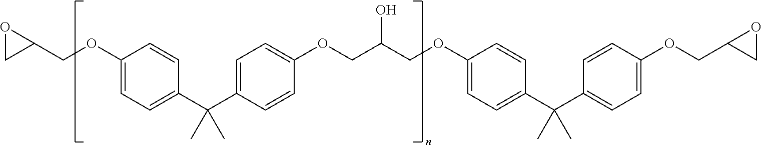

In one embodiment of the present invention, the one-part structural adhesive described herein above, component A) is present in an amount of from 5 to 25 weight percent; component B) is present in an amount of from 1 to 60 weight percent; component C) is present in an amount of from 1 to 8 weight percent; component D) is present in an amount of from 0.1 to 3 weight percent; and component E) is present in an amount of form 0 to 30 weight percent, wherein weight percents are based on the total weight of the one-part structural adhesive.

In one embodiment of the present invention, the one-part structural adhesive described herein above, the reaction mixture of component A) comprises: i) 10 to 95 weight percent of the polyether, ii) 2 to 60 weight percent of the hydroxyl-terminated polybutadiene, iii) 2 to 40 weight percent the polyisocyanate, iv) 0 to 20 weight percent chain extender, and v) 0.1 to 50 weight percent the capping group, wherein weight percents are based on the total weight of the reaction mixture.

### BRIEF DESCRIPTION OF THE DRAWINGS

FIG. 1 is a photograph of the 10% lap shear failure demonstrated by Example 12.

FIG. 2 is a photograph of the 40% lap shear failure demonstrated by Example 6.

FIG. 3 is a photograph of the 100% lap shear failure demonstrated by Example 20.

### DETAILED SUMMARY OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to details of the present invention in more detail than is necessary for the fundamental understanding of the present invention, the description making apparent to those skilled in the art how the several forms of the present invention may be embodied in practice.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from 1 to 50, it is deemed to include, for example, 1, 7, 34, 46.1, 23.7, or any other value or range within the range. Similarly, when a parameter, variable, or other quantity, is described with a set of upper values, and a set of lower values, then this is to be understood as an express disclosure of all ranges formed from each pair of upper and lower values.

The present invention is a toughened one component epoxy adhesive composition demonstrating improved resistance to humidity. The one-part structural adhesive of the present invention comprises, consists essentially of, consists of: A) a blocked PU-polymer toughener compound; B) an epoxy resin component comprising a solid epoxy resin, a liquid epoxy resin, or mixture thereof; C) a curing agent; D) a urea compound; and E) optionally a filler, wherein the blocked PU-polymer toughener (A) is a reaction product of a reaction mixture comprising, consisting essentially of, consisting of: i) a polyether, ii) a hydroxyl-terminated polybutadiene, iii) a polyisocyanate, iv) a chain extender, and v) a capping group.

Surprisingly, we found that increasing the overall hydrophobicity of the one component epoxy adhesive composition, specifically its toughener component, is humidity resistance is significantly improved and results in improved dynamic properties of the cured one component epoxy adhesive composition. We achieved this improvement by designing a toughener with specific building blocks disclosed herein below. Additionally the curing accelerator composition and amount play an important role.

Toughened one-component epoxy adhesives are used extensively in the automotive and other industries for metal-metal bonding as well as bonding metals to other materials. These adhesives often contain “tougheners” that help the cured adhesive resist failure. The tougheners have blocked isocyanate groups that, under the conditions of the curing reaction, can become de-blocked and react with an epoxy resin, for example a hydroxyl group of an epoxy resin such as DER331. Tougheners of this type are described, for example, in U.S. Pat. Nos. 5,202,390, 5,278,257, WO 2005/118734, WO 2007/003650, WO2012/091842, US Published Patent Application No. 2005/0070634, US Published Patent Application No. 2005/0209401, US Published Patent Application 2006/0276601, EP-A-0 308 664, EP 1 498 441A, EP-A 1 728 825, EP-A 1 896 517, EP-A 1 916 269, EP-A 1 916 270, EP-A 1 916 272 and EP-A-1 916 285.

The toughener is an elastomeric material that has terminal capped isocyanate groups, preferably a blocked PU-polymer toughener compound (A). The toughener is made in a process that includes the steps of chain-extending a mixture of isocyanate-terminated compounds and then capping the remaining isocyanate groups of the chain-extended material.

The isocyanate-terminated compounds include i) at least one 1,000 to 10,000 number average molecular weight isocyanate-terminated polyether and ii) at least one 1,000 to 10,000 number average molecular weight isocyanate-terminated diene polymer.

The polyether portion of the isocyanate-terminated polyether may be a polymer of one or more of tetrahydrofuran (tetramethylene oxide), sometimes referred to as a polytetrahydrofuran-diol polymer, 1,2-butylene oxide, 2,3-butylene oxide, 1,2-propylene oxide and ethylene oxide, with polymers or copolymers of at least 70 weight percent, based on the total weight of the polymer or copolymer, of tetrahydrofuran, 1,2-butylene oxide, 2,3-butylene oxide and 1,2-propylene oxide being preferred. Polymers of at least 80 weight percent tetrahydrofuran, based on the total weight of the polymer or copolymer are especially preferred.

The isocyanate-terminated polyether is conveniently prepared by the reaction of an amine- or hydroxyl-terminated polyether with a polyisocyanate, at a ratio of at least 1.5 equivalents, preferably 1.8 to 2.5 equivalents or 1.9 to 2.2 equivalents, of polyisocyanate per equivalent of amine- and/or hydroxyl groups on the starting polyether. The starting polyether preferably has 2 to 3, more preferably 2, amine and or hydroxyl groups per molecule. The polyisocyanate preferably has 2 isocyanate groups per molecule. The isocyanate-terminated polyether preferably has 2 to 3, more preferably 2, isocyanate groups per molecule. The starting polyether preferably has a number average molecular weight of 900 to 8000, more preferably 1,500 to 6,000 or 1,500 to 4,000. The polyisocyanate preferably has a molecular weight of up to 300.

The isocyanate-terminated diene polymer is conveniently prepared by the reaction of an amine- or hydroxyl-terminated diene polymer with a polyisocyanate, at a ratio of at least 1.5 equivalents, preferably 1.8 to 2.5 equivalents or 1.9 to 2.2 equivalents, of polyisocyanate per equivalent of amine- and/or hydroxyl groups on the starting diene polymer.

The starting diene polymer preferably has a glass transition temperature, prior to reaction with the polyisocyanate, of no greater than −20° C. and preferably no greater than −40° C. The diene polymer is preferably a polybutadiene polyol. The conjugated diene is preferably butadiene or isoprene, with butadiene being especially preferred.

The starting diene polymer preferably has 2 to 3, more preferably 2, amine and/or hydroxyl groups per molecule. The polyisocyanate preferably has 2 isocyanate groups per molecule. The isocyanate-terminated diene polymer preferably has 2 to 3, more preferably 2, isocyanate groups per molecule. The starting diene polymer preferably has a number average molecular weight of 900 to 8000, more preferably 1,500 to 6,000 and still more preferably 2,000 to 3,000. The polyisocyanate preferably has a molecular weight of up to 300.

The isocyanate-terminated polyether and isocyanate-terminated diene polymer can have aromatic isocyanate groups, but the isocyanate groups are preferably aliphatic. When the isocyanate-terminated polymers are made in the process described above, the polyisocyanate may be an aromatic polyisocyanate, but it is preferably an aliphatic polyisocyanate such as isophorone diisocyanate, 1,6-hexamethylene diisocyanate, hydrogenated toluene diisocyanate, hydrogenated methylene diphenylisocyanate (H₁₂MDI), and the like.

The isocyanate-terminated polyether and isocyanate-terminated diene polymer may be made separately and then blended. Alternatively, they are made simultaneously by blending an amine- or hydroxyl-terminated polyether and an amine- or hydroxyl-terminated diene polymer, each as described above, and reacting the blended materials with a polyisocyanate to form the mixture of isocyanate-terminated species directly.

The weight ratio of isocyanate-terminated polyether and isocyanate-terminated diene polymer may be, for example, 5:95 to 95:5. A preferred weight ratio is 50:50 to 95:5 and a more preferred ratio is 70:30 to 90:10.

The reaction to form the isocyanate-terminated polymers can be performed by combining the materials in the stated ratios and heating to 60 to 120° C., optionally in the presence of a catalyst for the reaction of isocyanate groups with the isocyanate-reactive groups of the polyether or diene polymer. The reaction is continued until the isocyanate content is reduced to a constant value, or to a target value, or until the amine- and or hydroxyl groups of the starting polyether or diene polymer are consumed.

If desired, branching can be introduced into the isocyanate-terminated polyether and/or isocyanate-terminated diene polymer. When they are made a process such as described before, this can be done by adding branching agent into the reaction between the polymeric starting materials and the polyisocyanate. The branching agent, for purposes of this invention, is a polyol or polyamine compound having a molecular weight of up to 599, preferably from 50 to 500, and at least three hydroxyl, primary amino and/or secondary amino groups per molecule. If used at all, branching agents generally constitute no more than 10%, preferably no more than 5% and still more preferably no more than 2% of the combined weight of the branching agent and the starting polymer (i.e., the amine- or hydroxyl-terminated polyether or diene polymer). Examples of branching agents include polyols such as trimethylolpropane, glycerin, trimethylolethane, ethylene glycol, diethylene glycol, propylene glycol, dipropylene glycol, sucrose, sorbitol, pentaerythritol, triethanolamine, diethanolamine and the like, as well as alkoxylates thereof having a number average molecular weight of up to 599, especially up to 500.

The mixture of isocyanate-terminated polyether and isocyanate-terminated diene polymer is chain extended to produce a chain extended, isocyanate-terminated prepolymer. Chain extenders include polyol or polyamine compounds having a molecular weight of up to 749, preferably from 50 to 500, and two hydroxyl, primary amino and/or secondary amino groups per molecule. Examples of suitable chain extenders include aliphatic diols such as ethylene glycol, diethylene glycol, triethylene glycol, propylene glycol, dipropylene glycol, tripropylene glycol, 1,4-butanediol, 1,6-hexane diol, cyclohexanedimethanol and the like; aliphatic or aromatic diamines such as ethylene diamine, piperazine, aminoethylpiperazine, phenylene diamine, diethyltoluenediamine and the like, and compounds having two phenolic hydroxyl groups such resorcinol, catechol, hydroquinone, bisphenol, bisphenol A, bisphenol AP (1,1-bis(4-hydroxylphenyl)-1-phenyl ethane), bisphenol F, bisphenol K, bisphenol M, tetramethylbiphenol and o,o′-diallyl-bisphenol A, and the like. Among these, the compounds having two phenolic hydroxyl groups are preferred. A preferred polyol is a hydroxy-terminated butadiene homopolymer or copolymer such as polybutadiene diol.

The chain extension reaction is performed in the same general manner as the prepolymer-forming reaction. Enough of the prepolymers are mixed with the chain extender to provide at least two equivalents of isocyanate groups per equivalent of isocyanate-reactive groups contributed by the chain extender. 1.5 to 4 or more, preferably 1.75 to 3 and more preferably 1.8 to 2.5 equivalents of isocyanate groups may be provided per equivalent of isocyanate-reactive groups contributed by the chain extender during the chain extension reaction.

The chain extension reaction is performed by combining the mixture of isocyanate-terminated polyether and isocyanate-terminated diene polymer with the chain extender, and subjecting the mixture to conditions under which the isocyanate-reactive groups of the chain extender react isocyanate groups of the isocyanate-terminated materials to form the chain-extended prepolymer.

The chain-extended prepolymer will be a mixture of materials. It will consist mainly of isocyanate-terminated polymers that correspond to two or more of the starting isocyanate-terminated polymers coupled together by residue(s) of the chain extender. In one embodiment, a portion of the prepolymer molecules will have two or more polyether chains, corresponding to the polyether chains of the isocyanate-terminated polyether. In another embodiment, a portion of the prepolymer molecules will have one or more polyether chains, corresponding to the polyether chains of the isocyanate-terminated polyether, and one or more diene polymer chains, corresponding to the diene polymer chains of the isocyanate-terminated diene polymer. There may be prepolymer molecules that having two more diene polymer chains, corresponding to the diene polymer chains of the isocyanate-terminated diene polymer. The chain-extended prepolymer may contain small quantities of unreacted starting materials, and/or of reaction products of one molecule of chain extender with only one molecule of isocyanate-terminated polyether or isocyanate-terminated diene polymer.

Conditions for the chain-extension reaction are generally as described with respect to the reaction of the amine- or hydroxyl-terminated polymer with the polyisocyanate.

The isocyanate groups of the chain-extended prepolymer are then capped by reaction with a capping group. Various types of capping groups are suitable including those described in U.S. Pat. Nos. 5,202,390, 5,278,257, 7,615,595, US Published Patent Application Nos. 2005-0070634, 2005-0209401, 2006-0276601 and 2010-0019539, WO 2006/128722, WO 2005/118734 and WO 2005/0070634, all incorporated herein by reference.

Among the useful capping agents are:

a) Aliphatic, aromatic, cycloaliphatic, araliphatic and/or heteroaromatic monoamines that have one primary or secondary amino group. Examples of such capping compounds include monoalkyl amines such as methyl amine, ethyl amine, isopropyl amine, sec-butylamine, t-butyl amine; dialkyl amines such as dimethylamine, diethylamine, diisopropylamine, di-sec-butylamine, dihexylamine and dioctyl amine; cyclohexylamine or dicyclohexylamine wherein the cyclohexyl groups are optionally substituted with one or more alkyl groups; benzylamine and diphenylamine wherein the phenyl groups are optionally substituted with one or more alkyl groups; morpholine; N-alkylpiperadines and imidazoles having an amine hydrogen atom.

b) phenolic compounds, including monophenols, polyphenols and aminophenols. Examples of monophenols include phenol, alkyl phenols that contain one or more alkyl groups that each may contain from 1 to 30 carbon atoms, naphthol, a halogenated phenol, cardanol, or naphthol. A preferred alkyl phenol is cashew nut shell liquid (CNSL), sometimes referred to as cardanol. Suitable polyphenols contain two or more, preferably two, phenolic hydroxyl groups per molecule and include resorcinol, catechol, hydroquinone, bisphenol, bisphenol A, bisphenol AP (1,1-bis(4-hydroxylphenyl)-1-phenyl ethane), bisphenol F, bisphenol K, bisphenol M, tetramethylbiphenol and o,o′-diallyl-bisphenol A, as well as halogenated derivatives thereof. Suitable aminophenols are compounds that contain at least one primary or secondary amino group and one phenolic hydroxyl group. The amino group is preferably bound to a carbon atom of an aromatic ring. Examples of suitable aminophenols include 2-aminophenol, 4-aminophenol, various aminonaphthols, and the like. Among the phenolic compounds, the monophenols and aminophenols are generally preferred.

c) Benzyl alcohol, which may be substituted with one or more alkyl groups on the aromatic ring;

d) Hydroxy-functional acrylate or methacrylate compounds such as 2-hydroxyethylacrylate, 2-hydroxypropylacrylate, 4-hydroxybutylacrylate, 2-hydroxybutylacrylate, 2-aminopropylacrylate, 2-hydroxyethylmethacrylate, 2-hydroxypropyl-methacrylate, 4-hydroxybutylmethacrylate and 2-hydroxybutylmethacrylate;

e) thiol compounds such as alkylthiols having 2 to 30, preferably 6 to 16, carbon atoms in the alkyl group, including dodecanethiol;

f) alkyl amide compounds having at least one amine hydrogen such as acetamide and N-alkylacetamide; and

g) a ketoxime.

The monophenol and aminophenol capping agents are generally preferable. In some embodiments, at least 90%, preferably at least 95%, more preferably at least 98%, up to 100% of the isocyanate groups of the prepolymer are capped with capping agents of one or more of these types. In such embodiments any remaining uncapped isocyanate groups may be capped with another type of capping agent.

The capping reaction can be performed under the general conditions described already, i.e., by combining the materials in the stated ratios and allowing them to react at room temperature or an elevated temperature such as 60 to 120° C., optionally in the presence of a catalyst for the reaction of isocyanate groups with the isocyanate-reactive groups of the capping agent. The reaction is continued until the isocyanate content is reduced to a constant value, which is preferably less than 0.1% by weight. Fewer than 3%, preferably fewer than 1%, of the isocyanate groups may remain uncapped.

The resulting toughener suitably has a number average molecular weight of at least 3,000, preferably at least 4,000, to 35,000, preferably to 25,000 and more preferably to 20,000, as measured by GPC, taking into account only those peaks that represent molecular weights of 1,000 or more.

An especially preferred prepolymer contains an average of from 1.9 to 2.2 capped isocyanate groups per molecule.

The toughener should constitute at least 5 weight percent of the adhesive composition. The amount of toughener may be at least 8 weight percent or at least 10 weight percent. The toughener may constitute up to 45 weight percent thereof, preferably up to 30 weight percent and more preferably up to 25 weight percent.

In a preferred embodiment, the PU-polymer toughener (A) is a reaction mixture comprising: i) from 10 to 95 weight percent of the polyether, ii) from 2 to 60 weight percent of the hydroxyl-terminated polybutadiene, iii) from 2 to 40 weight percent the polyisocyanate, iv) from 0 to 20 weight percent chain extender, and v) from 0.1 to 50 weight percent the capping group, wherein weight percents are based on the total weight of the reaction mixture.

Epoxy resins (B) useful in this invention include a wide variety of curable epoxy compounds and combinations thereof. Useful epoxy resins include liquids, solids, and mixtures thereof. Suitable epoxy resins include those described at column 2, line 66 to column 4, line 24 of U.S. Pat. No. 4,734,332, incorporated herein by reference. The epoxy resin should have an average of at least 1.8 epoxide groups per molecule. The epoxy resin(s) are not rubber-modified, meaning that, prior to curing the adhesive, the epoxy resins are not chemically bonded to a rubber.

Typically, the epoxy compounds are epoxy resins which are also referred to as polyepoxides. Polyepoxides useful herein can be monomeric (e.g., the diglycidyl ether of bisphenol A, diglycidyl ether of bisphenol F, digylcidyl ether of tetrabromobisphenol A, novolac-based epoxy resins, and tris-epoxy resins), higher molecular weight resins (e.g., the diglycidyl ether of bisphenol A advanced with bisphenol A) or polymerized unsaturated monoepoxides (e.g., glycidyl acrylates, glycidyl methacrylate, allyl glycidyl ether, etc.) to homopolymers or copolymers. Most desirably, epoxy compounds contain, on the average, at least one pendant or terminal 1,2-epoxy group (i.e., vicinal epoxy group) per molecule. Suitable epoxy resins include diglycidyl ethers of polyhydric phenol compounds such as resorcinol, catechol, hydroquinone, biphenol, bisphenol A, bisphenol AP (1,1-bis(4-hydroxylphenyl)-1-phenyl ethane), bisphenol F, bisphenol K and tetramethylbiphenol; diglycidyl ethers of aliphatic glycols such as the diglycidyl ethers of C₂₋₂₄ alkylene glycols; polyglycidyl ethers of phenol-formaldehyde novolac resins (epoxy novolac resins), alkyl substituted phenol-formaldehyde resins, phenol-hydroxybenzaldehyde resins, cresol-hydroxybenzaldehyde resins, dicyclopentadiene-phenol resins and dicyclopentadiene-substituted phenol resins; cycloaliphatic epoxy resins, and any combination of any two or more thereof. Solid epoxy resins that may be used in the present invention can preferably comprise or preferably be mainly based upon Bisphenol A. For example, a preferred epoxy resin is diglycidyl ether of bisphenol A Dow Chemical DER 664 UE solid epoxy.

One preferable epoxy resin has general formula:

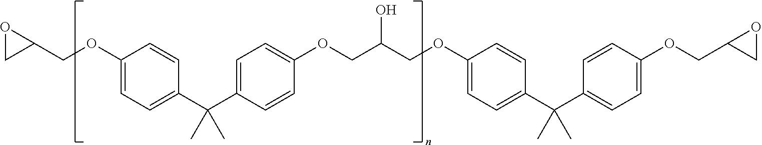

where n is generally in the range of 0 to 25. Basic liquid resins, e.g. DER 331, have epoxy equivalent weights in the range of 180-195 g/mol. Others, such as DER 332, can have epoxy equivalent weights in the range of about 170 to 175 g/mol. DER 330 can have epoxy equivalent weights in the range of about 176 to 185 g/mol.

Combinations of epoxy resins may be used to adjust properties of the epoxy adhesive. In compositions and methods of the present invention, the epoxy adhesive may comprise any amount of epoxy resin. Preferably, the liquid and/or solid epoxy resin comprises more than or 35 wt %, more preferably more than or 40 wt %, of the epoxy adhesive. Preferably, the liquid and/or solid epoxy resin comprises less than or 60 wt %, more preferably less than or 55 wt %, of the epoxy adhesive.

Suitable epoxy resins include diglycidyl ethers of bisphenol A resins such as are sold by The Dow Chemical Company under the designations DER 330, DER 331, DER 332, DER 383, DER 661 and DER 662 resins.

Suitable epoxy novolac resins that are commercially available include those sold as DEN 354, DEN 431, DEN 438 and DEN 439 from The Dow Chemical Company.

Suitable cycloaliphatic epoxy resins include those described in U.S. Pat. No. 3,686,359, incorporated herein by reference. Cycloaliphatic epoxy resins of particular interest are (3,4-epoxycyclohexyl-methyl)-3,4-epoxy-cyclohexane carboxylate, bis-(3,4-epoxycyclohexyl) adipate, vinylcyclohexene monoxide and mixtures thereof.

Other suitable epoxy resins include oxazolidone-containing compounds as described in U.S. Pat. No. 5,112,932. In addition, an advanced epoxy-isocyanate copolymer such as those sold commercially as DER 592 and DER 6508 (Dow Chemical) can be used.

The epoxy resin preferably is one or more diglycidyl ethers of a polyhydric phenol or a mixture thereof with up to 10 percent by weight of another type of epoxy resin. The most preferred epoxy resins are diglycidyl ethers of bisphenol-A and diglycidyl ethers of bisphenol-F. These can have average epoxy equivalent weights of from 170 to 600 or more, preferably from 225 to 400.

An especially preferred epoxy resin is a mixture of at least one diglycidyl ether of a polyhydric phenol, preferably bisphenol-A or bisphenol-F, having an epoxy equivalent weight of from 170 to 299, especially from 170 to 225, and at least one second diglycidyl ether of a polyhydric phenol, again preferably bisphenol-A or bisphenol-F, this one having an epoxy equivalent weight of at least 300, preferably from 310 to 600. The proportions of the resins are preferably such that the mixture has an average epoxy equivalent weight of from 225 to 400. The mixture optionally may also contain up to 20%, preferably up to 10%, of one or more other epoxy resins.

The epoxy resin preferably will constitute at least 25 weight percent of the adhesive, more preferably at least 30 weight percent, and still more preferably at least 40 weight percent. The epoxy resin may constitute up to 75 weight percent of the adhesive, more preferably up to 60 weight percent.

In some embodiments, the adhesive composition contains 30 to 60, preferably 40 to 60, weight percent of a diglycidyl ether of bisphenol A that has an epoxy equivalent weight of up to 225, and 0 to 10 weight percent, preferably 2 to 6 weight percent, of a diglycidyl ether of bisphenol A that has an epoxy equivalent weight of 400 or greater, preferably 400 to 1500. Such an adhesive composition optionally contains 0.5 to 10 weight percent of a different epoxy resin such as an epoxy novolac resin or an epoxy cresol novolac resin.

The adhesive of the present invention also contains a latent curing agent (C). A curing agent is consider to be “latent” for purposes of this invention if the adhesive, as set forth above, exhibits a curing temperature of at least 60° C. The curing temperature preferably is at least 80° C., and may be at least 100° C. or at least 140° C. It may be as high as, for example, 180° C. The “curing temperature” refers to the lowest temperature at which the structural adhesive achieves at least 30% of its lap shear strength (DIN ISO 1465) at full cure within 2 hours. The lap shear strength at “full cure” is measured on a sample that has been cured for 30 minutes at 180° C., which conditions represent “full cure” conditions.

Suitable latent curing agents include materials such as boron trichloride/amine and boron trifluoride/amine complexes, melamine, diallylmelamine, guanamines such as dicyandiamide, methyl guanidine, dimethyl guanidine, trimethyl guanidine, tetramethyl guanidine, methylisobiguanidine, dimethylisobiguanidine, tetramethylisbiguandidine, heptamethylisobiguanidine, hexamethylisobiguanidine, acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones. Dicyandiamide is a particularly preferred curing agent.

The latent curing agent is used in an amount sufficient to cure the adhesive. Typically, enough of the curing agent is provided to consume at least 80% of the epoxide groups present in the composition. A large excess over that amount needed to consume all of the epoxide groups is generally not needed. Preferably, the curing agent constitutes at least 1 weight percent of the adhesive, more preferably at least 2 weight percent and even more preferably at least 3 weight percent thereof. The curing agent preferably constitutes up to 15 weight percent of the adhesive composition, more preferably up to 10 weight percent, and most preferably up to 8 weight percent.

The adhesive of the present invention further contains at least one urea compound (D) having one or more urea groups and a molecular weight per urea group of up to 250. The urea compound(s) may have the structure:

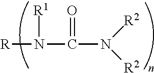

wherein n is 1 or more, R is an unsubstituted or unsubstituted alkyl, cycloalkyl and/or aromatic radical, R¹ is hydrogen, unsubstituted alkyl, substituted alkyl, phenyl or substituted phenyl, and each R² is independently alkyl, substituted alkyl, phenyl or substituted phenyl. R may be the residue, after removal of isocyanate groups, from a mono- or polyisocyanate compound. R may contain, for example, up to 20 carbon atoms, preferably up to 15 carbon atoms. Preferably, R, each R² and R¹ (if not hydrogen) are bonded to the adjacent nitrogen atom through an aliphatic carbon atom. n is preferably 1 to 4, more preferably 1, 2 or 3, and most preferably 2.

Examples of aromatic ureas include dimethyl phenyl ureas such as 3-phenyl-1,1-dimethylurea, 3-(p-chlorophenyl)-1,1-dimethylurea, 3-(3,4-dichlorophenyl)-1,1-dimethyl urea.

Other aromatic ureas include those corresponding to reaction products of an aromatic polyisocyanate with a dialkyl amine. Examples include 2,4′- and/or 4,4′-methylene bis(phenyl dimethyl urea) and 2,4- and/or 2,6-toluene bis(dimethyl urea).

Examples of aliphatic ureas include tetraalkyl urea compounds in which the alkyl groups each independently have 1 to 12, preferably 1 to 2 carbon atoms, such as tetramethylurea and tetraethylurea.

A preferred type of aliphatic urea corresponds to a reaction product of an aliphatic (including cycloaliphatic) isocyanate with a dialkyl amine. Examples include isophorone bis(dimethyl urea), cyclohexane bis(dimethyl urea), hexane-1,6-bis(dimethyl urea), 4,4′-methylene bis(cyclohexane dimethyl urea), and the like. Preferred commercially available urea curing agents are isophorone bis(dimethylurea) under the tradename Omicure U35, 4,4′-methylene bis(phenyl dimethyl urea) under the tradename Omicure U52, and phenyl dimethyl urea under the tradename Omicure U405 all available from Emerald Performance Materials.

Preferably, the urea compound constitutes at least 0.1 weight percent of the adhesive, more preferably at least 0.5 weight percent and even more preferably at least 1 weight percent thereof. The curing agent preferably constitutes up to 5 weight percent of the adhesive composition, more preferably up to 4 weight percent, and most preferably up to 3 weight percent.

The adhesive of the invention may contain various other, optional ingredients, in addition to those described above.

The adhesive of the present invention may contain one or more filler (E). These can perform several functions, such as (1) modifying the rheology of the adhesive in a desirable way, (2) reducing overall cost per unit weight, (3) absorbing moisture or oils from the adhesive or from a substrate to which it is applied, and/or (4) promoting cohesive, rather than adhesive, failure. Examples of suitable mineral fillers include calcium carbonate, calcium oxide, talc, carbon black, textile fibers, glass particles or fibers, aramid pulp, boron fibers, carbon fibers, mineral silicates, mica, powdered quartz, hydrated aluminum oxide, bentonite, wollastonite, kaolin, fumed silica, silica aerogel, polyurea compounds, polyamide compounds or metal powders such as aluminum powder or iron powder. Another filler of particular interest is a microballoon having an average particle size of up to 200 microns and density of up to 0.2 g/cc. The particle size is preferably 25 to 150 microns and the density is preferably from 0.05 to 0.15 g/cc. Heat expandable microballoons which are suitable for reducing density include those commercially available from Dualite Corporation under the trade designation Dualite, and those sold by Akzo Nobel under the trade designation Expancel.

All or part of the mineral filler may be in the form of fibers having a diameter of 1 to 50 μm (D50, as measured by microscopy) and an aspect ratio of 6 to 20. The diameter of the fibers may be 2 to 20 μm or 2 to 10 μm, and the aspect ratio may be 8 to 20 or 8 to 16. The diameter of the fiber is taken as that of a circle having the same cross-sectional area as the fiber. The aspect ratio of the fibers may be 6 or more, such as 6 to 25, 6 to 20, 8 to 20 or 8 to 15.

Alternatively, all or part of the mineral filler may be in the form of low aspect ratio particles having an aspect ratio of 5 or less and a longest dimension of up to 100 μm, preferably up to 25 μm.

The mineral filler(s) may constitute, for example, 1 to 40 weight percent, preferably 1 to 30 weight percent of the total weight of the adhesive composition. In some embodiments, it constitutes at least 5 weight percent or at least 7.5 weight percent of the weight of the adhesive composition, and may constitute up to 25 weight percent, up to 20 or up to 15 weight percent of the total weight of the adhesive.

The adhesive may contain up to 10 percent by weight, preferably 1 to 6 percent by weight of fumed silica based on the total weight of the adhesive.

The adhesive of the present invention may further comprise one or more additional component (F) common to one-part structural adhesives. For example, the adhesive may include a rubber component that does not include capped isocyanate groups, which is a separate material from the toughener described above. Such a rubber component is optional and can be omitted. One advantage of this invention is that excellent properties can be obtained even when the adhesive is devoid of such a component.

The optional rubber component may be, for example, a liquid rubber, preferably having two or more epoxide-reactive groups, such as amino or preferably carboxyl groups. It is preferred that at least a portion of the liquid rubber has a glass transition temperature (T_{g}) of −40° C. or lower, especially −50° C. or lower, as measured by differential scanning calorimetry. Such a liquid rubber component may be entirely or partially reacted with an epoxy resin to form a rubber-modified epoxy resin that has epoxy groups.

Such a liquid rubber is preferably a homopolymer or copolymer of a conjugated diene, especially a diene/nitrile copolymer. The conjugated diene rubber is preferably butadiene or isoprene, with butadiene being especially preferred.

Another type of rubber that may be present in the adhesive composition is a core-shell rubber. The core-shell rubber is a particulate material having a rubbery core. The rubbery core preferably has a T_{g} of less than −20° C., more preferably less than −50° C. and even more preferably less than −70° C. The T_{g} of the rubbery core may be well below −100° C. The core-shell rubber also has at least one shell portion that preferably has a T_{g} of at least 50° C. The core of the core-shell rubber may be a polymer or copolymer of a conjugated diene such as butadiene, or a lower alkyl acrylate such as n-butyl-, ethyl-, isobutyl- or 2-ethylhexylacrylate, or may be a silicone rubber. The shell polymer, which is optionally chemically grafted or crosslinked to the rubber core, is preferably polymerized from at least one lower alkyl methacrylate such as methyl-, ethyl- or t-butyl methacrylate. Homopolymers of such methacrylate monomers can be used. Further, up to 40% by weight of the shell polymer can be formed from other monovinylidene monomers such as styrene, vinyl acetate, vinyl chloride, methyl acrylate, ethyl acrylate, butyl acrylate, and the like. The molecular weight of the grafted shell polymer is generally between 20,000 and 500,000. Examples of useful core-shell rubbers include those described in EP 1 632 533 A1 and those sold by Kaneka Corporation under the designation Kaneka Kane Ace, including Kaneka Kane Ace MX 156 and Kaneka Kane Ace MX 120 core-shell rubber dispersions.

The total rubber content of the adhesive of the invention can range from as little as 0 weight percent to as high as 30 weight percent, based on the total weight of the adhesive. If a rubber is present at all, a preferred rubber content is up to 20 weight percent, up to 15 weight percent or up to 5 weight percent. No portion of the elastomeric toughener is considered in calculating total rubber content.

In specific embodiments, the adhesive of the invention has a total rubber content of no more than 5%, preferably no more than 1%, and more preferably no more than 0.5% by weight. The adhesive may have a rubber content of zero.

A further optional component is a monomeric or oligomeric, addition polymerizable, ethylenically unsaturated material is optionally present in the adhesive composition. This material should have a molecular weight of less than 1500. This material may be, for example, an acrylate or methacrylate compound, an unsaturated polyester, a vinyl ester resin, or an epoxy adduct of an unsaturated polyester resin. A free radical initiator can be included in the adhesive composition as well, in order to provide a source of free radicals to polymerize this material. The inclusion of an ethylenically unsaturated material of this type provides the possibility of effecting a partial cure of the adhesive through selective polymerization of the ethylenic unsaturation.

The adhesive composition can further contain other additives such as dimerized fatty acids, diluents, plasticizers, extenders, pigments and dyes, fire-retarding agents, thixotropic agents, expanding agents, flow control agents, adhesion promoters and antioxidants.

Suitable expanding agents include both physical and chemical type agents. The adhesive may also contain a thermoplastic powder such as polyvinylbutyral or a polyester polyol, as described in WO 2005/118734.

The foregoing adhesive composition is formed into a layer at a bondline between two substrates to form an assembly, and the adhesive layer is cured at the bondline to form an adhesive bond between the two substrates.

The adhesive can be applied to the substrates by any convenient technique. It can be applied cold or be applied warm if desired. It can be applied manually and/or robotically, using for example, a caulking gun, other extrusion apparatus, or jet spraying methods. Once the adhesive composition is applied to the surface of at least one of the substrates, the substrates are contacted such that the adhesive is located at a bondline between the substrates.

After application, the adhesive is cured by heating it to at or above its curing temperature. Generally, this temperature is at least 60° C., and is preferably 80° C. or above, more preferably 140° C. or above. Preferably, the temperature is 180° C. or less.

The adhesive of the invention can be used to bond a variety of substrates together including wood, metal, coated metal, aluminum, a variety of plastic and filled plastic substrates, fiberglass and the like. In one preferred embodiment, the adhesive is used to bond parts of automobiles together or to bond automotive parts onto automobiles. Such parts can be steel, coated steel, galvanized steel, aluminum, coated aluminum, plastic and filled plastic substrates.

An application of particular interest is bonding of automotive frame components to each other or to other components. The frame components are often metals such as cold rolled steel, galvanized metals, or aluminum, which are frequently contaminated with an oil as described above. The components that are to be bonded to the frame components can also be metals as just described, or can be other metals, plastics, composite materials, and the like.

Assembled automotive frame members are usually coated with a coating material that requires a bake cure. The coating is typically baked at temperatures that may range from 140° C. to over 200° C. In such cases, it is often convenient to apply the adhesive in the body shop of an automotive line to the frame components (which may be coated with an oil as described above), then apply the coating, and cure the adhesive at the same time the coating is baked and cured. Between the steps of applying the adhesive and applying the coating, the assembly may be fastened together to maintain the substrates and adhesive in a fixed position relative to each other, until the curing step is performed. Mechanical means can be used as a fastening device. These include, for example, temporary mechanical means such as various types of clamps, bands and the like, which can be removed once the curing step is completed. The mechanical fastening means can be permanent, such as, for example, various types of welds, rivets, screws, and/or crimping methods. Alternatively or in addition, the fastening can be done by spot-curing one or more specific portions of the adhesive composition to form one or more localized adhesive bonds between the substrates while leaving the remainder of the adhesive uncured until a final curing step is performed after the coating is applied.

### EXAMPLES

The following examples are provided to illustrate the invention but are not intended to limit the scope thereof. All parts and percentages are by weight unless otherwise indicated. All molecular weights are number averages unless otherwise indicated.

Table 1 list the raw materials which are used for in the tougheners Examples 1 to 5.

TABLE 1

| Component | | Supplier | Chemistry |
|---|---|---|---|
| a | PolyTHF 2000 | BASF | Polytetrahydrofuran-diol 2000 g/mol |
| b | PolyBD R45 HTLO | Cray Valley | PBD: Polybutadiene diol 2800 g/mol |
| c | Desmodur H | Bayer | 1,6-Hexamethylene diisocyanate |
| e | Homid 127A | HOS | o,o′-diallylbisphenol A |
| f | Cardolite NX 2026 | Cardolite | Cardanol |
| g | Dabco T12 N | Air Products | Dibutyltindialuerate |

Toughener synthesis.

Tougheners are made via a 3-step process or a 2-step process described herein below, amounts of components [a} to [g] are in wt % unless otherwise noted:

2-step process:

1. First reaction step: Component [a] and [b] are added into a lab reactor and heated up to 120° C. The mixture is mixed for 30 min at 120° C. under vacuum, then cooled down to 60° C. When the mixture reaches 60° C. component [c] is added and mixed. After 2 minutes, of component [g] is added and the mixture is allowed to react at 85° C. (bath temperature) for 45 min under nitrogen.

2. Second reaction step: Component [e] and [f] is added to the resultant mixture from step 1 and the mixture is stirred for 90 min at 95° C. under nitrogen (bath temperature). Finally, the mixture is stirred for 10 min at 95° C. under vacuum for degassing.

3 step process:

1. First reaction step: Component [a] and [b] are added into a lab reactor and heated up to 120° C. The mixture is mixed for 30 min at 120° C. under vacuum, then cooled down to 60° C. When the mixture reaches 60° C. component [c] is added and mixed, after 2 min component [g] is added and the mixture is allowed to react at 85° C. (bath temperature) for 45 min under nitrogen.

2. Second reaction step: Component [e] is added to the resultant mixture from step 1 and the mixture is stirred for 60 min at 95° C. (bath temperature) under nitrogen.

3. Third reaction step: component [f] is added to the resultant mixture from step 2 and the mixture is stirred for 90 min at 95° C. (bath temperature) under nitrogen. Finally, the mixture is stirred for 10 min at 95° C. under vacuum for degassing.

The compositions of tougheners Examples 1 to 5 are listed in Table 2.

TABLE 2

| EXAMPLE | | 1 | 2 | 3 | 4 | 5 |
|---|---|---|---|---|---|---|
| PROCESS | | 3-step | 3-step | 2-step | 2-step | 3-step |
| COMPONENT | | wt % | wt % | wt % | wt % | wt % |
| a | PolyTHF 2000 | 53.71 | 50.41 | 39.59 | 33.27 | 65.22 |
| b | PolyBD R45 HTLO | 7.08 | 7.09 | 5.32 | 5.26 | 7.57 |
| c | Desmodur H | 13.42 | 16.81 | 26.40 | 33.27 | 0.00 |
| e | Homide 127A | 12.62 | 12.58 | 12.32 | 12.16 | 13.17 |
| f | Cardolite NX 2026 | 13.11 | 13.05 | 16.31 | 15.98 | 13.98 |
| g | DABCO T 12 N | 0.06 | 0.06 | 0.06 | 0.06 | 0.06 |

Table 3 lists the raw materials which are used in epoxy adhesive compositions Examples 6 to 20.

TABLE 3

| Component | Supplier | Description |
|---|---|---|
| DER 331 | Dow | Liquid DGEBA resin |
| Solid-liquid | Mixture of Dow | Solid DGEBA resin |
| epoxy resin mix | Resins* | |
| Bis A capped PU | Toughener B as | Bis A capped PU polymer |
| polymer (RAM F) | described in WO | |
| | 2005/007766 Al | |
| Struktol 3604 | S&S Schill & | X8 CTBN-LER adduct: 60:40 |
| | Seilacher | |
| EP 49-10P2 | Adeka | Phosphorous containing |
| | | epoxy resin |
| Epoxy silane | Momentive | Silquest A 187 |
| colorant | Huntsman | Color pigment paste |
| Amicure CG 1200 | Airproducts | Dicyandiamide |
| Omicure U52 | Emerald | 4,4′-methylene bis |
| | | (phenyldimethyl urea) |
| Omicure U35 | Emerald | Isophorone bis(dimethylurea) |
| Omicure U405 | Emerald | Phenyl dimethyl urea |
| Curing | Accelerator II as | Tris-2,4,6-tris(dimethylamino- |
| accelerator | described in | methyl)phenol embedded into a |
| | US 4,659,779 | polyvinyl phenol polymer matrix |
| Omyalite 95T | Omya | Calcium carbonate |
| Nyglos 8 | NYCO Minerals | Wollastonite |
| Talc 1N | IMCD Deutschland | Talc |
| Chaux Vive | Lhoist | Calcium oxide |
| K25 | 3M | Hollow glass spheres |
| Fumed silica | Evonik | Fumed silica |

*D.E.R 671 to 331 = 40:60

Adhesive compositions Examples 6 to 20 are summarized in Table 4. Examples 6 to 9 and 11 differ only in the toughener composition. The hydrophobicity of the toughener and the adhesive formulation increases with the following ranking: 8>11>7>6>9. Examples 10 to 13 are the same with the exception of the curing accelerator amount; the amount of the accelerator decreases from 10 to 13. Examples 14 to 16 and 17 to 19 differ only in the accelerator composition and the amount. Examples 10 to 16 contain a urea kind of accelerator, whereas Examples 17 to 19 a Mannich base kind of accelerator.

The following rheological, thermal, and physical properties are determined for the adhesive compositions Examples 6 to 20 and the results are reported in Table 5:

“GPC Method” System: Malvern: Viscotek GPCmax/Viscotek TDA; Column: Mixed-D Precolumn followed by Agilent Mixed-D 300*7.5 Multdetection System (Viscotek TDA): RI, Viscosity, RALS, LALS; Eluent: THF; Flow: 1.0 ml/min; Standard: PS; and Calculation: absolute Molecular Weight (Universal Calibration: H. Benoit, J. Polym. Sci. B, 5 (1967), pp. 753-759)

“Rheology” is rotatory viscosity and yield stress determined using a Bohlin CS-50 Rheometer, C/P 20, up/down 0.1-20 s/1; evaluation according to Casson model;

“DSC” differential scanning calorimetry is determined using a Mettler Toledo DSC 821 with Star Software from 25 to 250° C. with 10°/min ramp up;

“Lap shear strength” is determined according to DIN EN 1465 using a test speed of 10 mm/min: 10×25 mm bonded area, 0.3 mm adhesive layer thickness and the failure mode is reported as: CF (cohesive failure) or AF (adhesion failure) as a percent failure from 0 to 100 (where 100% is complete failure);

“Impact peel strength” is determined according to ISO 11343 using a test speed of 2 m/s: 20×30 mm bonded area, 0.3 mm adhesive layer thickness;

and

“Tensile properties” tensile strength, elongaiton, and elastic modulus are determined according to DIN EN ISO 527-1 using a test speed 10 mm/min.

Mechanical testing is performed using steel specimens that are hot dipped zinc coated steel: 420LAD+Z100 MB, with a thickness of 1.2 mm and electrolytically zinc coated steel HC 300LAD+ZE 75-75 with a thickness 1.0 mm as supplied by Voest Alpine.

The humidity exposure test is performed using lap shear specimens by applying the adhesive composition following the DIN procedure and the given bonding area dimension. The sample is procured for 6 minutes at 170° C., followed by exposure at 40° C. and 98% relative humidity for 5 weeks. Prior to evaluating, the specimen is conditioned for a minimum of one hour at 23° C./50% relative humidity, and a final cure in an oven for 25 minutes at 175° C. Test results are reported

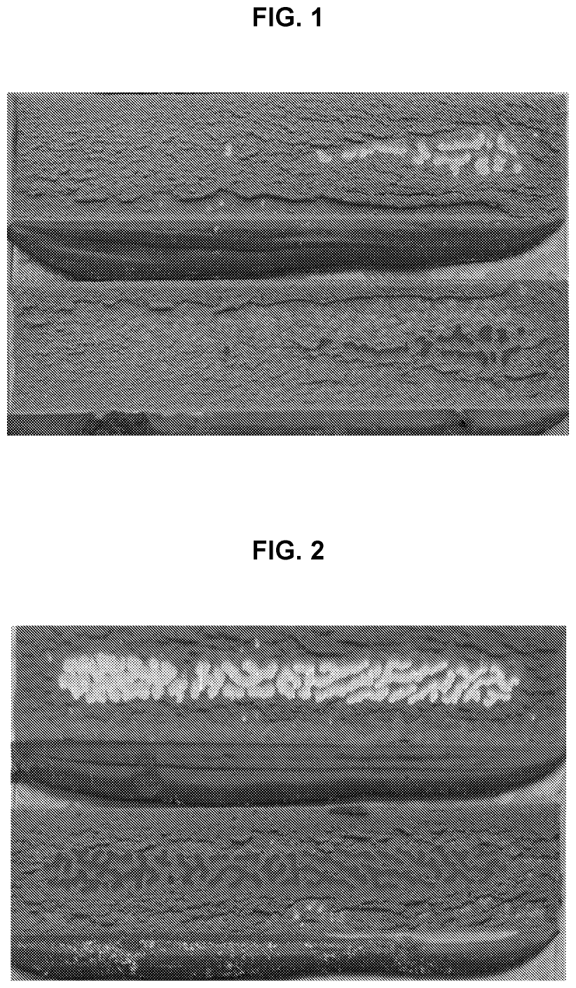

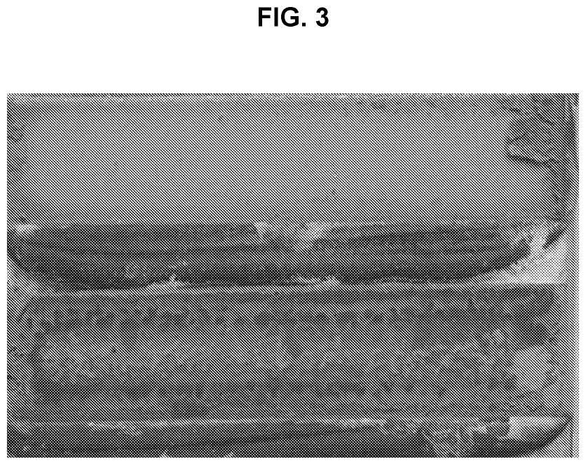

FIG. 1 to FIG. 3 show photographs of the lap shear test specimens of Example 12 (10%), Example 6 (40%), and Example 20 (100%) adhesion failure, respectively.

TABLE 4

| Example | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|
| DER 331 | 18.4 | 18.4 | 18.4 | 18.4 | 18.21 | 18.4 | 18.45 | 18.49 | 18.22 | 18.49 | 18.54 | 18.22 | 18.49 | 18.54 | 12.4 |
| Solid-liquid epoxy* | 18.4 | 18.4 | 18.4 | 18.4 | 18.21 | 18.4 | 18.45 | 18.5 | 18.21 | 18.5 | 18.55 | 18.21 | 18.5 | 18.55 | 12.4 |
| EP 49-10P2 | 7.5 | 7.5 | 7.5 | 7.5 | 7.5 | 7.5 | 7.5 | 7.5 | 7.5 | 7.5 | 7.5 | 7.5 | 7.5 | 7.5 | 7.5 |
| Struktol 3604 | 0 | 0 | 0 | 0 | 0 | 0 | 0 | 0 | 0 | 0 | 0 | 0 | 0 | 0 | 20 |
| A (80/20) | 20 | 0 | 0 | 0 | 0 | 0 | 0 | 0 | 0 | 0 | 0 | 0 | 0 | 0 | 0 |
| B (75/25) | 0 | 0 | 0 | 0 | 20 | 20 | 20 | 20 | 20 | 20 | 20 | 20 | 20 | 20 | 0 |
| C (60/40) | 0 | 20 | 0 | 0 | 0 | 0 | 0 | 0 | 0 | 0 | 0 | 0 | 0 | 0 | 0 |
| D (50/50) | 0 | 0 | 20 | 0 | 0 | 0 | 0 | 0 | 0 | 0 | 0 | 0 | 0 | 0 | 0 |
| E (100/0) | 0 | 0 | 0 | 20 | 0 | 0 | 0 | 0 | 0 | 0 | 0 | 0 | 0 | 0 | 12 |
| Epoxy silane | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 |
| colorant | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| Amicure CG 1200 | 2.8 | 2.8 | 2.8 | 2.8 | 2.77 | 2.8 | 2.8 | 2.81 | 2.78 | 2.81 | 2.82 | 2.78 | 2.81 | 2.82 | 2.8 |
| Omicure U52 | 0.4 | 0.4 | 0.4 | 0.4 | 0.8 | 0.4 | 0.3 | 0.2 | 0 | 0 | 0 | 0 | 0 | 0 | 0.4 |
| Omicure U35 | 0 | 0 | 0 | 0 | 0 | 0 | 0 | 0 | 0 | 0 | 0 | 0 | 0 | 0 | 0 |
| Omicure U405 | 0 | 0 | 0 | 0 | 0 | 0 | 0 | 0 | 0.8 | 0.2 | 0.1 | 0 | 0 | 0 | 0 |
| Curing accelerator\hat{ } | 0 | 0 | 0 | 0 | 0 | 0 | 0 | 0 | 0 | 0 | 0 | 0.8 | 0.2 | 0.1 | 0 |
| Omyalite 95T | 9 | 9 | 9 | 9 | 9 | 9 | 9 | 9 | 9 | 9 | 9 | 9 | 9 | 9 | 9 |
| Nyglos 8 | 6 | 6 | 6 | 6 | 6 | 6 | 6 | 6 | 6 | 6 | 6 | 6 | 6 | 6 | 6 |
| Talk 1N | 0 | 0 | 0 | 0 | 0 | 0 | 0 | 0 | 0 | 0 | 0 | 0 | 0 | 0 | 0 |
| Chaux Vive | 9 | 9 | 9 | 9 | 9 | 9 | 9 | 9 | 9 | 9 | 9 | 9 | 9 | 9 | 9 |
| K25 | 1 | 1 | 1 | 1 | 1 | 1 | 1 | 1 | 1 | 1 | 1 | 1 | 1 | 1 | 1 |
| Fumed silica | 6.3 | 6.3 | 6.3 | 6.3 | 6.3 | 6.3 | 6.3 | 6.3 | 6.3 | 6.3 | 6.3 | 6.3 | 6.3 | 6.3 | 6.3 |

*DGEBA epoxy resin mix: DER 330:671 = 60:40
\hat{ }tris-2,4,6-tris(dimethylaminomethyl)phenol embedded into a polyvinyl phenol polymer matrix

TABLE 5

| Example | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|
| INITIAL | | | | | | | | | | | | | | | |
| RHEOLOGICAL DATA | | | | | | | | | | | | | | | |
| Viscosity, Casson @ | 84 | 101 | 123 | 57 | 76 | 91 | 82 | 81 | | 82 | | | 90 | | 87 |
| 45° C., Pas | | | | | | | | | | | | | | | |
| Yield stress, Casson | 560 | 517 | 518 | 787 | 735 | 738 | 772 | 738 | | 784 | | | 618 | | 818 |
| @ 45° C., Pa | | | | | | | | | | | | | | | |
| Elastic Modulus, MPa | 2450 | 2290 | 2250 | 2520 | | 2450 | | 2460 | | 2500 | | | 2350 | | 2130 |
| Elongation, % | 5 | 5 | 5 | 4 | | 4 | | 5 | | 4 | | | 4 | | 4 |
| Tensile Strength, MPa | 35 | 33 | 32 | 36 | | 34 | | 33 | | 33 | | | 34 | | 25 |
| DSC, peak max, ° C. | 193 | 193 | 193 | 194 | 189 | 193 | 195 | 195 | 186 | 194 | 196 | 183 | 194 | 195 | 192 |
| DSC, onset, ° C. | 182 | 181 | 181 | 182 | 176 | 179 | 182 | 182 | 174 | 181 | 183 | 161 | 175 | 180 | 178 |
| DSC, reaction | 203 | 200 | 199 | 197 | 192 | 195 | 191 | 191 | 201 | 198 | 191 | 188 | 183 | 185 | 198 |
| enthalpy, J/g | | | | | | | | | | | | | | | |
| LAP SHEAR | | | | | | | | | | | | | | | |
| STRENGTH, MPa | | | | | | | | | | | | | | | |
| Initial* | 28.3 | 27.4 | 26.3 | 26.6 | 28.2 | 28.3 | 27.7 | 27.2 | 28.6 | 27.9 | 26.9 | 29.4 | 26.2 | 26.9 | 10.7 |
| Failure mode | 90 CF | 100 | 100 | 30 CF | 100 | 100 | 100 | 90 CF | 100 | 100 | 100 | 100 | 100 | 100 | 0 CF |
| | | CF | CF | | CF | CF | CF | | CF | CF | CF | CF | CF | CF | |
| EXPOSURE TEST\hat{ } | 26.5 | 25.8 | 25.8 | 26.7 | 22.3 | 25.7 | 27.9 | 26.6 | 17.7 | 27.5 | 24.8 | 22.9 | 25.9 | 23.9 | 17.5 |
| Adhesion Failure in % | 40 | 20 | 10 | 50 | 70 | 30 | 10 | 5 | 80 | 5 | 0 | 60 | 5 | 0 | 100 |
| IMPACT PEEL | | | | | | | | | | | | | | | |
| STRENGTH, N/mm | | | | | | | | | | | | | | | |
| DC56 + Z100; 23° C. | 31 | 26 | 21 | 25 | | 31 | | 27 | | 29 | | | 28 | | 8 |

*steel combination HC 420LAD + Z100MB/HC 300LAD + ZE 75-75
\hat{ }precuring 6 minutes at 170° C. object temperature, followed by 40° C. at 98% relative humidity for 5 weeks, conditioning for minimum one hour at 23° C./50% relative humidity, final cure 25 minutes at 175° C. in an oven

What is claimed is:

1. A one-part structural adhesive comprising:
A) a blocked PU-polymer toughener compound;
B) an epoxy resin component comprising a solid epoxy resin, a liquid epoxy resin, or mixture thereof;
C) a curing agent;
D) a urea compound;
and
E) optionally a filler,
wherein the blocked PU-polymer toughener (A) is a reaction product of a reaction mixture comprising:
i) a polyether,
ii) a hydroxyl-terminated polybutadiene,
iii) a polyisocyanate,
iv) a chain extender,
and
v) a capping group.

2. The one-part structural adhesive of claim 1 wherein the polyether (A) (i) is a polytetrahydrofuran-diol polymer.

3. The one-part structural adhesive of claim 1 wherein the polyisocyanate (A) (iii) is 1,6-hexamethylene diisocyanate.

4. The one-part structural adhesive of claim 1 wherein the capping group (A) (iv) is cashew nut shell liquid oil.

5. The one-part structural adhesive of claim 1 comprising an epoxy resin (B) having the formula:

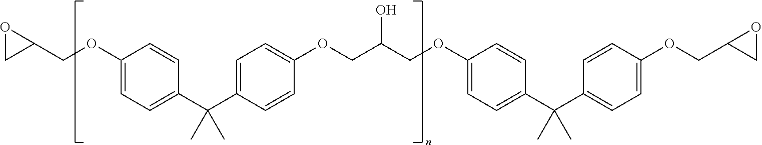

6. The one-part structural adhesive of claim 1 wherein the urea compound (D) is a phenyl dimethyl urea.

7. The one-part structural adhesive of claim 1 wherein the filler (E) is one or more of fumed silica, calcium carbonate, calcium oxide, wollastonite, talc, glass beads, and hollow glass spheres.

8. The one-part structural adhesive of claim 1 wherein:
A) 5 to 25 weight percent of the blocked PU-polymer toughener compound;
B) the epoxy resin component comprises 1 to 10 weight percent of a solid epoxy resin and 30 to 60 weight percent of a liquid epoxy resin;
C) 1 to 8 weight percent of the curing agent;
D) 0.1 to 3 weight percent of the urea compound;
and
E) 0 to 30 weight percent of the filler,
wherein weight percents are based on the total weight of the one-part structural adhesive.

9. The one-part structural adhesive of claim 1 wherein the blocked PU-polymer toughener (A) reaction mixture comprises:
i) 10 to 95 weight percent of the polyether,
ii) 2 to 60 weight percent of the hydroxyl-terminated polybutadiene,
iii) 2 to 40 weight percent the polyisocyanate,
iv) 0 to 20 weight percent chain extender,
and
v) 0.1 to 50 weight percent the capping group,
wherein weight percents are based on the total weight of the reaction mixture.
